(19) United States
(12) Patent Application Publication
(10) Pub. No.: US 2007/0053180 A1
(43) Pub. Date: Mar. 8, 2007

(54) Night writing instrument and method of use

(76) Inventors: Lorine V. Jones, Prince George, VA (US); Sonovia Jones, Prince George, VA (US)

Correspondence Address: Galasso & Associates, LP, P.O. Box 26503, Austin, TX, 78755-0503, US

(21) Appl. No.: 11/218,668

(22) Filed: Sep. 2, 2005

(51) Int. Cl. B43K 29/10

(52) U.S. Cl. 362/118

(57) ABSTRACT

A writing instrument for writing in low light or dark conditions. The writing instrument is moved from a retracted non-writing position to an extended writing position. The writing instrument comprises a light bulb, a battery and a pressure mechanism. When the writing instrument is placed in a writing position and pressure is applied to the tip the light bulb is illuminated. The pressure mechanism causes the battery to illuminate the light bulb. Because the light bulb is built into head of the outer casing of the writing instrument, the light bulb shines directly onto the writing surface making it easy for the user to see what is being written.

### FIELD OF THE DISCLOSURE

A writing instrument capable of illuminating a writing surface thereby allowing the user to write in low light or dark conditions.

### BACKGROUND

Most everyone has had an occasion when they needed to write something and did not have enough light to be able to see to write. This is particularly so for students. Typically, when large classes are taught the lights are turned down to provide for overhead viewing of a light screen. This is particular more popular now that it is so easy to attach computers up to these types of screens and then the teacher can have more of an interactive concept going.

While this makes viewing much simpler and allows for more interaction within a class, it makes taking notes more of a challenge. For example, if the lights are turned off, it can be very dark and almost, if not impossible, to take notes. There are number of small light type instruments available for providing light in these types of conditions, however, several of them require electricity. Others, while they require batteries, are required to be switched on an off. These types of lights can range from a small flashlight to a small night light type configuration. While these types of lights provide the necessary lighting to take notes, they can actually provide too much light and become annoying to those sitting around you.

Students are not the only ones that face these types of dilemmas. Others who might have a need to be able to take notes or write in the dark might include movie and play critics, police officers, firemen, private investigators and pageant judges. All of these types of people have a need to write in low light conditions or in the dark on a continuous basis.

There are a number of writing instruments that are currently on the market that light up the cylinder of the pen. These provide a small amount of light but not really enough light to take notes. These types of lights are more for ornamentality than functionality. Many of these types of writing instruments are sold for the attractiveness and yet you still get the added bonus of actually having a writing instrument. Very few people actually end up using the light part of these types of writing instrument. Most of the time the light is more of a nuisance because they tend to be more of a fluorescent light. Additionally, these types of lights require the actual turning on and off of the light.

Once concept previously disclosed is In U.S. Pat. No. 1,517,153. This patent disclosed the concept of a fountain pen comprising a lamp. In this disclosure, the fountain pen comprises a battery and a lamp. When the pen is held in the writing position, the battery shifts with gravity toward the lamp causing the lamp circuit to close, thereby causing the lamp to illuminate. While this is an alternative to providing light on the writing instrument, there are problems associated with this type of configuration. For example, there are a number of reasons why the battery could cease to shift, leaving the circuit open and the lamp inoperable. Additionally, you would be required to rotate the fountain pen every time you desired to turn the light on or off. Also, storage of the fountain pen could be problematic. You would have to make sure that the pen was always stored with the writing portion in an upward manner. Otherwise, the lamp would stay illuminated during storage causing the battery and the bulb to need replacing.

### SUMMARY OF THE DISCLOSURE

In one embodiment of the present invention the night writing instrument comprises an outside casing.

In another embodiment the night writing instrument comprises a tube of ink.

In yet another embodiment the outside casing encompasses the tube of ink.

In still another embodiment the night writing instrument comprises a tip for dispensing ink.

In another embodiment the tip is operable to move from a non-writing position to a writing position.

In yet another embodiment the night writing instrument comprises a light bulb.

In still another embodiment the light bulb is recessed within the outside casing.

In another embodiment the night writing instrument comprises a battery.

In yet another embodiment the battery is enclosed within the outside casing.

In still another embodiment the battery is operable to illuminate the light bulb.

In another embodiment the night writing instrument comprises a pressure mechanism.

In yet another embodiment the pressure mechanism causes the light bulb to illuminate when the tip is moved into a writing position and pressure is placed on the tip.

In still another embodiment the battery is connected to the light bulb.

In another embodiment the light bulb operates to illuminate the writing material.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a perspective view of a writing instrument.

FIG. 2 is a front view of the writing instrument detailing the internal parts.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

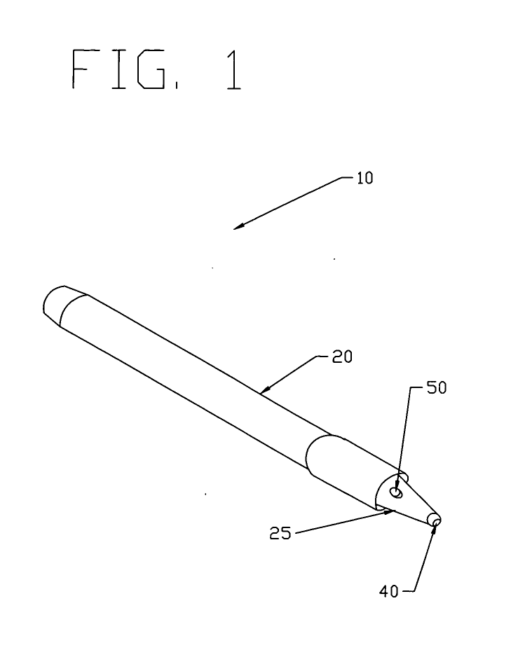

FIG. 1 is a perspective view of a writing instrument 10 comprising an outside casing 20, a head 25, an ink tube 30, a tip 40, a light bulb 50, a battery 60 and a pressure mechanism 70. The writing instrument 10 allows a user to be able to write in low light conditions as well as dark conditions. By moving the writing instrument 10 from a non-writing position to writing position and then placing pressure on the tip 40, the light bulb 50 is illuminated making it possible for a user to have an illuminated writing surface. There are a number of ways to move the writing instrument 10 from a non-writing retracted position to an extended writing position. For example, some pens are equipped with a twisting mechanism while other are equipped with a spring actuated retraction device. Once the writing instrument 10 is in an extended writing position, pressure must be placed on the tip 40 which in turn causes the light bulb 50 to illuminate. Since the light bulb 50 is located in the head 25 of the outer casing 20, the light bulb 50 is capable of shining directly on the writing surface. When pressure is removed from the tip 40, the light bulb 50 ceases to illuminate. While the light bulb 50 is illuminated, the writing surface is visible to the user and the user can begin to dispense ink from the ink tube 30 by moving the tip 40 over the writing surface.

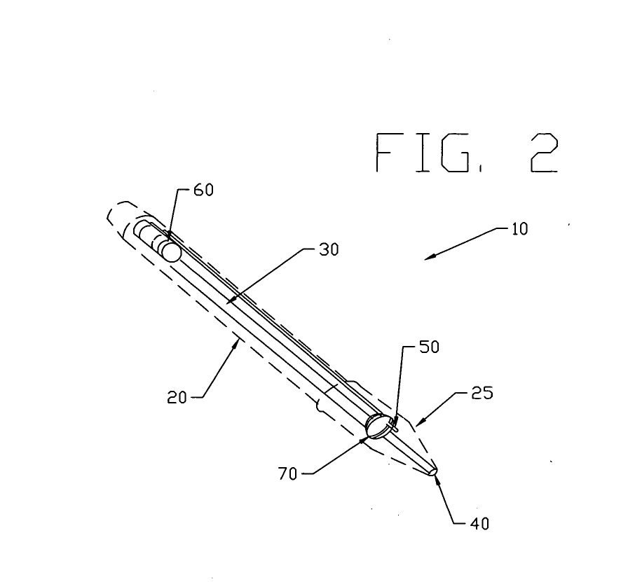

FIG. 2 illustrates an internal view of the writing instrument 10 by depicting the light bulb 50, the battery 60 and the pressure mechanism 70. The light bulb 50 is activated by applying pressure to the pressure mechanism 70. Pressure is applied to the pressure mechanism 70 through the tip 40. Once the pressure mechanism 70 is engaged, the battery 60 operates to cause the illumination of the light bulb 50.

When the user has completed writing, pressure from the tip 40 would be reduced, the light bulb 50 would cease to illuminate and the writing instrument 10 would be moved to a non-writing position. Should the user wish to continue to writing is a short period of time, the user would maintain the writing instrument 10 in an extended position. In the event, the user has completed the writing process and wishes to put the writing instrument 10 away, the user would move the writing instrument 10 to a non-writing retracted position. At that point, the light bulb 50 would not be illuminated and the writing instrument 10 would not able to dispense ink from the ink tube 30.

Both FIG. 1 and FIG. 2 illustrate the writing instrument 10 in a writing position, wherein the tip 40 is extended from the outer casing 20.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A writing instrument comprising:
an outside casing, wherein said outside casing encompasses a tube comprising ink;
a tip for dispensing the ink, wherein the tip is operable to move from a non-writing position to a writing position;
a light bulb recessed in the outside casing;
a battery enclosed within said outside casing and operable to illuminate said light bulb; and
a pressure mechanism wherein said pressure mechanism causes the light bulb to illuminate when said tip is moved in said writing position from a first position wherein pressure is not placed on the tip to a second position wherein pressure is placed on the tip.

2. A writing instrument of claim 1, wherein the battery is connected to the light bulb.

3. A writing instrument of claim 1, wherein said light bulb operates to illuminate the writing material.

4. A writing instrument of claim 1, wherein said light bulb illuminates when pressure is placed on the tip.

5. A writing instrument of claim 1, wherein said light bulb ceases to illuminate when pressure is removed from the tip of the pen.

6. A writing instrument of claim 1, wherein said battery is a “AAA” battery.

7. A writing instrument of claim 1, wherein said battery is a watch type battery.

8. A method for writing in the dark wherein a writing instrument comprising an p1 outer casing comprising a head, a tube comprising ink, a tip for dispensing ink
attached to said tube, a light bulb recessed in said head, a battery enclosed within said outer case and a pressure mechanism, said method comprising the steps of:
moving the tip from a non-writing retracted position to an extended writing position;
moving the tip to a writing material;
placing pressure on the tip causing the pressure mechanism to illuminate the light bulb;
moving the writing instrument and tip to cause ink to be dispensed on the writing material;
removing the tip of the writing instrument from the writing material to cause the light bulb to no longer illuminate; and
moving the tip from the writing position to the non-writing position.

9. A pen for writing in low light conditions comprising;
an outer casing having a head;
a tube of ink encompassed within said outer casing;
a tip for dispensing ink from the tube; wherein said tip is operable to move from a retracted non-writing position to an extended writing position;
a light bulb recessed into said head of the outer casing;
a battery for supplying electricity to said light bulb; and
a pressure mechanism wherein said pressure mechanism causes the light bulb to illuminate when said tip is moved in said writing position from a first position wherein pressure is not placed on the tip to a second position wherein pressure is placed on the tip.

10. A pen of claim 9, wherein the light bulb ceases to illuminate when pressure is removed from the pressure mechanism by lifting said tip from the writing material.

11. A pen of claim 9, wherein the battery is a “AAA” battery.

12. A pen of claim 9, wherein the battery is a watch type battery.
